(19) United States
(12) Patent Application Publication
(10) Pub. No.: US 2026/0188881 A1
(43) Pub. Date: Jul. 2, 2026

(54) PHASE SHIFTER AND ANTENNA

(71) Applicants: Beijing BOE Sensor Technology Co., Ltd., Beijing (CN); BOE Technology Group Co., Ltd., Beijing (CN); Beijing BOE Technology Development Co., Ltd., Beijing (CN)

(72) Inventors: Haocheng JIA, Beijing (CN); Zhifeng ZHANG, Beijing (CN); Hao GUO, Beijing (CN); Yan LU, Beijing (CN); Wenxue MA, Beijing (CN)

(21) Appl. No.: 18/727,634

(22) PCT Filed: Apr. 18, 2023
(86) PCT No.: PCT/CN2023/088901

§ 371 Date: Jul. 9, 2024

(51) Int. Cl. H01P 1/18; H01Q 3/36

(52) U.S. Cl. CPC H01P 1/18; H01Q 3/36

(57) ABSTRACT

A phase shifter includes a first dielectric substrate and a second dielectric substrate opposite to each other, a tunable dielectric layer between the first dielectric substrate and the second dielectric substrate, a first electrode layer on a side of the first dielectric substrate close to the tunable dielectric layer, a second electrode layer on a side of the second dielectric substrate close to the tunable dielectric layer, and a third electrode layer on a side of the first dielectric substrate away from the tunable dielectric layer. One of the first electrode layer or the second electrode layer includes a signal electrode for transmitting electromagnetic waves. The third electrode layer is provided with a first opening, and orthographic projections of the first opening and the signal electrode on the first dielectric substrate are partially overlapped.

### TECHNICAL FIELD

The present disclosure belongs to the technical field of communications, and specifically relates to a phase shifter and an antenna.

### BACKGROUND

The phased array antenna is an antenna that changes a pattern shape by controlling a feeding phase of the radiation unit in the array antenna, which changes a pointing direction of a maximum value in the antenna pattern by controlling the phase, thereby achieving the object of beam scanning. Due to the beam scanning characteristics, phased array antennas are widely used in the fields of communications and sounding and the like.

The phased array antenna architectures are divided into two types, i.e., active phased array antennas and passive phased array antennas. The current phased array antenna based on the liquid crystal technology is essentially a typical passive phased array antenna, which is a phased array architecture of high maturity, low cost and low power consumption. By means of the dielectric anisotropy of liquid crystal, the liquid crystal phased array antenna provides a deflection voltage for upper and lower parts respectively on and under a liquid crystal layer via a transmission line, and controls the deflection direction of the liquid crystal to change a phase shift amount of the phase shifter, so as to adjust the beam direction of the phased array antenna.

Phase shifters used in the liquid crystal phased array antennas are mainly classified into two types: the first type uses liquid crystal as a main dielectric on a transmission line, and directly changes a phase constant and a wave speed for electromagnetic wave transmission on the transmission line by regulating a dielectric constant of the liquid crystal, to realize a phase shifting function; and the second type uses a liquid crystal capacitor as variable capacitive loading to a transmission line trunk/branch, and creates proper capacitance-inductance resonance to amplify the influence of the liquid crystal dielectric constant on the phase constant, thereby amplifying the phase shift amount of a narrower band. Compared with the first type of liquid crystal phase shifter, the second type generally has the advantages of large phase shift amount in unit space, independence from a large cell gap, high energy efficiency and the like, but accordingly, also has the disadvantages of narrower bandwidth, poor linearity, low impedance caused by loading of a resonance branch and the like based on the principle of the second type. Generally, in a scenario where the requirement on the relative impedance bandwidth is ≤15% to 18%, application of the second type of liquid crystal phase shifter has dominant advantages; while under the requirement of a larger bandwidth, the introduction of an impedance matching section may make the broadband characteristic almost unavailable because the resonance branch is designed with strong capacitance in the working band while the device body has a low impedance.

The second type of liquid crystal phase shifter is generally based on the broadband idea of increasing the impedance after resonant loading, i.e., increasing the equivalent inductance of the phase shifter trunk while decreasing the equivalent capacitance of the branch. For a liquid crystal phase shifter that achieves phase shift based on branch capacitive regulation, decreasing the equivalent capacitance of the branch is obviously contradictory with increasing a quality factor (phase shift amount/insertion loss, hereinafter abbreviated as FOM) of the device. Both qualitative and quantitative analyses have demonstrated that decreasing the branch capacitance has a greater influence on the FOM than increasing the trunk inductance (with a thinner trunk width). Qualitative explanation is given here: considering that both methods achieve broadband matching at Z₀, the rise of the trunk inductance Lₜᵣᵤₙₖ only affects the ohmic loss on the trunk (which takes a very low proportion in the whole insertion loss), the phase shift amount is directly proportional to the branch capacitance Cb_{ranch}, and changes of the two are reflected in a local rise of the insertion loss and an overall reduction of the phase shift amount, respectively. Considering that the relationship between the two and the impedance, i.e., phase shifter impedance (analog filter Bloch impedance) Z₀=sgrt(Lₜᵣᵤₙₖ/C_{branch}), it can be known that doubling L achieves an effect the same as reducing C by ½, and apparently, the effect of multifold increase of an extremely small part of insertion loss on FOM is still not comparable to multifold decrease of the phase shift amount.

In a broadband path for increasing the trunk capacitance, the problem of an insufficient process tolerance due to a too narrow trunk, for example, with a width within 100 μm, may be encountered. Meanwhile, in practical engineering applications, even if the influence of ohmic loss in a fine line is smaller than the influence of reducing the branch capacitance, there is still an actual influence on the product design competitiveness.

### SUMMARY

To solve at least one of the technical problems in the existing art, the present disclosure provides a phase shifter and an antenna.

In a first aspect, an embodiment of the present disclosure provides a phase shifter, including a first dielectric substrate and a second dielectric substrate opposite to each other, a tunable dielectric layer between the first dielectric substrate and the second dielectric substrate, a first electrode layer on a side of the first dielectric substrate close to the tunable dielectric layer, a second electrode layer on a side of the second dielectric substrate close to the tunable dielectric layer, and a third electrode layer on a side of the first dielectric substrate away from the tunable dielectric layer; wherein
one of the first electrode layer or the second electrode layer includes a signal electrode for transmitting electromagnetic waves; and
the third electrode layer is provided with a first opening, and orthographic projections of the first opening and the signal electrode on the first dielectric substrate are partially overlapped.

The first electrode layer includes the signal electrode, the second electrode layer includes a first reference electrode and a second reference electrode; the first electrode layer further includes at least one first branch and at least one second branch respectively connected to two sides of an extending direction of the signal electrode; the orthographic projection of the signal electrode on the first dielectric substrate is between orthographic projections of the first reference electrode and the second reference electrode on the first dielectric substrate; orthographic projections of the at least one first branch and the first reference electrode on the first dielectric substrate are at least partially overlapped; and orthographic projections of the at least one second branch on the first dielectric substrate are at least partially overlapped.

The second electrode layer includes the signal electrode, the first electrode layer includes a first reference electrode and a second reference electrode; the second electrode layer further includes at least one first branch and at least one second branch respectively connected to two sides of an extending direction of the signal electrode; the orthographic projection of the signal electrode on the first dielectric substrate is between orthographic projections of the first reference electrode and the second reference electrode on the first dielectric substrate; orthographic projections of the first branch and the first reference electrode on the first dielectric substrate are at least partially overlapped; and orthographic projections of the at least one second branch on the first dielectric substrate are at least partially overlapped.

The at least one first branch each includes a first portion and a second portion, orthographic projections of the second portion and the first reference electrode on the first dielectric substrate are overlapped; the third electrode layer is further provided with a second opening, and orthographic projections of the first portion and the second opening on the first dielectric substrate are partially overlapped; and/or
the at least one second branch each includes a third portion and a fourth portion, and orthographic projections of the fourth portion and the second reference electrode on the first dielectric substrate are overlapped; and the third electrode layer is further provided with a third opening, and orthographic projections of the third portion and the third opening on the first dielectric substrate are partially overlapped.

In a case where the third electrode layer has the second opening, the second opening is in communication with the first opening; and in a case where the third electrode layer has the third opening, the third opening is in communication with the first opening.

In a case where the third electrode layer has the second opening, a center line of the first portion in an extending direction thereof coincides with a center line of the second opening in an extending direction thereof; and in a case where the third electrode layer has the third opening, a center line of the third portion in an extending direction thereof coincides with a center line of the third opening in an extending direction thereof.

A center line of the signal electrode in an extending direction thereof coincides with a center line of the first opening in an extending direction thereof.

A plurality of first branches and a plurality of second branches are provided in one-to-one correspondence.

The first reference electrode and the second reference electrode are each configured to be loaded with the same voltage as the third electrode layer.

The first electrode layer includes the signal electrode, the second electrode layer includes a plurality of patch electrodes arranged side by side in an extending direction of the signal electrode, and each of the patch electrodes has an orthographic projection on the first dielectric substrate overlapped with the orthographic projection of the signal electrode on the first dielectric substrate.

A center line of the signal electrode in an extending direction thereof coincides with a center line of the first opening in an extending direction thereof.

The first electrode layer includes the signal electrode, the second electrode layer includes a plurality of patch electrodes arranged side by side in an extending direction of the signal electrode; the signal electrode includes a first signal sub-electrode and a second signal sub-electrode arranged side by side, and two ends of each patch electrode are respectively overlapped with orthographic projections of the first signal sub-electrode and
the second signal sub-electrode on the first dielectric substrate; and the first opening includes a first sub-opening and a second sub-opening, and orthographic projections of the first signal sub-electrode and the first sub-opening on the first dielectric substrate are partially overlapped; and orthographic projections of the second signal sub-electrode and the second sub-opening on the first dielectric substrate are partially overlapped.

A center line of the first signal sub-electrode in an extending direction thereof coincides with a center line of the first sub-opening in an extending direction thereof, and/or a center line of the second signal sub-electrode in an extending direction thereof coincides with a center line of the second sub-opening in an extending direction thereof.

The tunable dielectric layer has a thickness not less than 1/10 μm.

The first conductive layer and the second conductive layer are each made of a material including at least one of molybdenum, aluminum or copper.

The third conductive layer is made of a material including at least one of copper, silver or gold.

The tunable dielectric layer is made of a material including liquid crystal molecules.

In a second aspect, an embodiment of the present disclosure provides an antenna, including any phase shifter as described above.

The antenna further includes a radiation unit electrically connected to the phase shifter.

The antenna further includes a feed unit electrically connected to the radiation unit through the phase shifting unit.

### BRIEF DESCRIPTION OF DRAWINGS

FIG. 1 is a top view of a first example of phase shifter according to an embodiment of the present disclosure.

FIG. 2 is a sectional view taken along A-A′ in FIG. 1.

FIG. 3 is a top view of a third electrode layer in the first example of phase shifter according to an embodiment of the present disclosure.

FIG. 4 is a top view of a second example of phase shifter according to an embodiment of the present disclosure.

FIG. 5 is a sectional view taken along B-B′ in FIG. 4.

FIG. 6 is a top view of a third example of phase shifter according to an embodiment of the present disclosure.

FIG. 7 is a sectional view taken along C-C′ in FIG. 6.

FIG. 8 is a top view of a third electrode layer in the third example of phase shifter according to an embodiment of the present disclosure.

FIG. 9 is a top view of a fourth example of phase shifter according to an embodiment of the present disclosure.

FIG. 10 is a sectional view taken along D-D′ in FIG. 9.

FIG. 11 is a top view of a fifth example of phase shifter according to an embodiment of the present disclosure.

FIG. 12 is a sectional view taken along E-E′ in FIG. 11.

FIG. 13 is a top view of a third electrode layer in the fifth example of phase shifter according to an embodiment of the present disclosure.

### DETAIL DESCRIPTION OF EMBODIMENTS

To improve understanding of the technical solution of the present disclosure for those skilled in the art, the present disclosure will be described in detail with reference to accompanying drawings and specific implementations.

Unless otherwise defined, technical or scientific terms used in the present disclosure are intended to have general meanings as understood by those skilled in the art to which the present disclosure belongs. The words “first”, “second” and similar terms used in the present disclosure do not denote any order, quantity, or importance, but are used merely for distinguishing different components from each other. Likewise, the words “a”, “an”, or “the” and similar referents do not denote a limitation of quantity, but rather denote the presence of at least one. The word “comprising” or “including” or the like means that the element or item preceding the word contains elements or items that appear after the word or equivalents thereof, but does not exclude other elements or items. The terms “connected” or “coupled” and the like are not restricted to physical or mechanical connections, but may include electrical connections, whether direct or indirect. The words “upper”, “lower”, “left”, “right”, and the like are merely used to indicate a relative positional relationship, and when an absolute position of the described object is changed, the relative positional relationship may be changed accordingly.

Before an introduction of the phase shifter according to the embodiments of the present disclosure is given, it should be noted that in the embodiments of the present disclosure, only the phase shifter being a liquid crystal phase shifter is taken as an example for illustration, that is, a tunable dielectric layer in the phase shifter is made of a material including liquid crystal molecules or a composite material containing liquid crystal molecules, which tunable dielectric layer is hereinafter referred to as a liquid crystal layer. However, it should be understood that the material of the tunable dielectric layer is not limited to liquid crystal molecules or a composite material containing liquid crystal molecules, and any dielectric with a variable dielectric constant under the action of an electric field is within the scope of the embodiments of the present disclosure.

In a first aspect, an embodiment of the present disclosure provides a phase shifter, including a first dielectric substrate, a second dielectric substrate, a liquid crystal layer, a first electrode layer, a second electrode layer, and a third electrode layer. The first dielectric substrate and the second dielectric substrate are disposed opposite to each other, the liquid crystal layer is located between the first dielectric substrate and the second dielectric substrate, the first electrode layer is disposed on a side of the first dielectric substrate close to the liquid crystal layer, the second electrode layer is disposed on a side of the second dielectric substrate close to the liquid crystal layer, and the third electrode layer is disposed on a side of the first dielectric substrate away from the liquid crystal layer. The liquid crystal layer is provided at least in an overlap region of the first electrode layer and the second electrode layer, and thus, by applying a bias voltage to the first electrode layer and the second electrode layer to generate an electric field in the overlap region, a dielectric constant of the liquid crystal layer is changed, and thus a phase of the transmitted electromagnetic waves is changed.

In particular, in the embodiments of the present disclosure, one of the first electrode layer or the second electrode layer includes a signal electrode (i.e., a trunk) for transmitting electromagnetic waves, and accordingly, a first opening is formed in the third conductive layer, and orthographic projections of the signal electrode and the first opening on the first dielectric substrate are partially overlapped.

It should be noted that the third electrode layer may be a radio frequency ground layer, that is, the third electrode layer is loaded with a ground voltage. However, it should be understood that the voltage loaded to the third electrode layer may be other reference voltages as long as a current loop can be formed with the first electrode layer and the second electrode layer.

In the embodiments of the present disclosure, since the orthographic projections of the signal electrode and the first opening on the first dielectric substrate are partially overlapped, the capacitance from the signal electrode to the third electrode layer can be reduced, while the inductance therebetween can be increased, and the impedance of the phase shifter can be increased, thereby realizing the broadband of the phase shifter.

In an embodiment of the present disclosure, the signal electrode may be disposed in the first electrode layer or the second electrode layer, and to clarify the structure of the phase shifter according to the embodiments of the present disclosure, the following description is made with reference to specific examples.

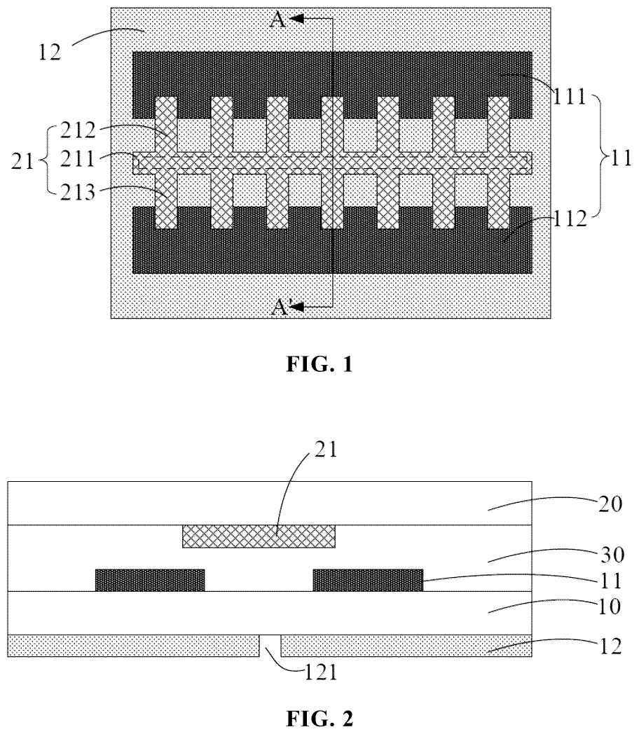

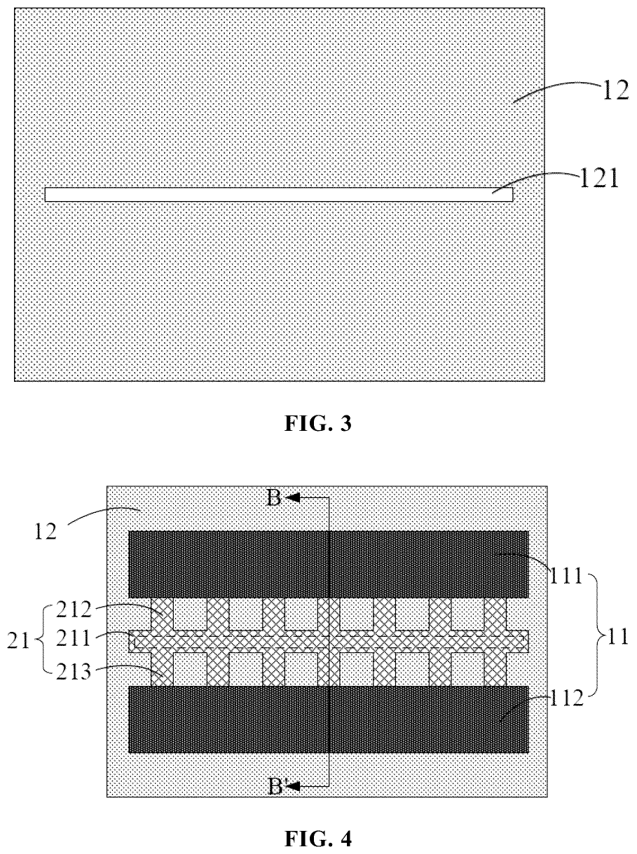

First example: FIG. 1 is a top view of a first example of phase shifter according to an embodiment of the present disclosure; FIG. 2 is a sectional view taken along A-A′ in FIG. 1; and FIG. 3 is a top view of a third electrode layer 12 in the first example of phase shifter according to an embodiment of the present disclosure. As shown in FIGS. 1 to 3, the phase shifter includes a first dielectric substrate 10, a second dielectric substrate 20, a liquid crystal layer 30, a first electrode layer 11, a second electrode layer 21, and a third electrode layer 12. The first dielectric substrate 10 and the second dielectric substrate 20 are disposed opposite to each other, the liquid crystal layer 30 is located between the first dielectric substrate 10 and the second dielectric substrate 20, the first electrode layer 11 is disposed on a side of the first dielectric substrate 10 close to the liquid crystal layer 30, the second electrode layer 21 is disposed on a side of the second dielectric substrate 20 close to the liquid crystal layer 30, and the third electrode layer 12 is disposed on a side of the first dielectric substrate 10 away from the liquid crystal layer 30. The liquid crystal layer 30 is provided at least in an overlap region of the first electrode layer 11 and the second electrode layer 21. The first electrode layer 11 of the phase shifter includes a first reference electrode 111 and a second reference electrode 112. The second electrode layer 21 includes a signal electrode 211, and a first branch 212 and a second branch 213 respectively connected to two sides of an extending direction of the signal electrode 211. An orthographic projection of the signal electrode 211 on the first dielectric substrate 10 is located between orthographic projections of the first reference electrode 111 and the second reference electrode 112 on the first dielectric substrate 10, orthographic projections of the first branch 212 and the first reference electrode 111 on the first dielectric substrate 10 are at least partially overlapped, and orthographic projections of the second branch 213 and the second reference electrode 112 on the first dielectric substrate 10 are at least partially overlapped. The signal electrode 211 serves as a trunk of the first electrode layer 11 for transmitting electromagnetic waves. The first branch 212 and the second branch 213 serve as branches of the first electrode layer 11 to form overlap capacitances respectively with the first reference electrode 111 and the second reference electrode 112, which overlap capacitances are used for phase shift of the electromagnetic waves transmitted by the trunk.

In this example, a first opening 121 is formed in the third electrode layer 12, and orthographic projections of the first opening 121 and the signal electrode 211 on the first dielectric substrate 10 are partially overlapped. For example: the first opening 121 is a rectangular slot, and in this case, a center line of the first opening 121 in an extending direction thereof coincides with a center line of the signal electrode 211 in an extending direction thereof. In this case, for the signal electrode 211 as the trunk, the capacitance from the trunk to the third electrode layer 12 can be reduced, while the inductance therebetween can be increased, and the impedance of the phase shifter can be increased, thereby realizing the broadband of the phase shifter.

Apparently, the first opening 121 may be a non-rectangular slot, and the shape of the first opening 121 is not limited in the embodiments of the present disclosure.

In some examples, the first reference electrode 111 and the second reference electrode 112 in the first electrode layer 11 may be ground electrodes, and in this case, the first reference electrode 111 and the second reference electrode 112 may be electrically connected to the third electrode layer 12. In this manner, reduced wiring and easy control can be achieved. Specifically, the first reference electrode 111 and the second reference electrode 112 in the first electrode layer 11 may be electrically connected to the third electrode layer 12 through a via running through the first dielectric substrate 10.

In some examples, a plurality of first branches 212 and a plurality of second branches 213 are provided in the second electrode layer 21 in one-to-one correspondence. In an embodiment of the present disclosure, the first branches 212 may be periodically arranged and electrically connected to the signal electrode 211, and similarly, the second branches 213 may also be periodically arranged and electrically connected to the signal electrode 211.

In some examples, each of the first electrode layer 11 and the second electrode layer 21 may be a single-layer film layer made of any one of molybdenum, aluminum or copper, or may be a composite film layer made of more than one of molybdenum, aluminum and copper. The first electrode layer 11 may be formed on the second dielectric substrate 20 by electroplating or sputtering. The second electrode layer 21 may be formed on the first dielectric substrate 10 by electroplating or sputtering.

In some examples, the third electrode layer 12 maybe a single-layer film layer made of any one of copper, silver or gold, or may be a composite film layer made of more than one of copper, silver and gold. The third electrode layer 12 maybe formed on the first dielectric substrate 10 by electroplating or sputtering.

Second example: FIG. 4 is a top view of a second example of phase shifter according to an embodiment of the present disclosure; and FIG. 5 is a sectional view taken along B-B′ in FIG. 4. As shown in FIGS. 4 and 5, the phase shifter in this example is substantially the same as that in the first example, except that in this example, the first electrode layer 11 includes a signal electrode 211, and a first branch 212 and a second branch 213 respectively connected to two sides of an extending direction of the signal electrode 211. The second electrode layer 21 includes a first reference electrode 111 and a second reference electrode 112. An orthographic projection of the signal electrode 211 on the first dielectric substrate 10 is located between orthographic projections of the first reference electrode 111 and the second reference electrode 112 on the first dielectric substrate 10, orthographic projections of the first branch 212 and the first reference electrode 111 on the first dielectric substrate 10 are at least partially overlapped, and orthographic projections of the second branch 213 and the second reference electrode 112 on the first dielectric substrate 10 are at least partially overlapped. The signal electrode 211 serves as a trunk of the first electrode layer 11 for transmitting electromagnetic waves. The first branch 212 and the second branch 213 serve as branches of the first electrode layer 11 to form overlap capacitances with the first reference electrode 111 and the second reference electrode 112, which overlap capacitances are used for phase shift of the electromagnetic waves transmitted by the trunk.

In this example, a first opening 121 is formed in the third electrode layer 12, and orthographic projections of the first opening 121 and the signal electrode 211 on the first dielectric substrate 10 are partially overlapped. For example: the first opening 121 is a rectangular slot, and in this case, a center line of the first opening 121 in an extending direction thereof coincides with a center line of the signal electrode 211 in an extending direction thereof. In this case, for the signal electrode 211 as the trunk, the capacitance from the trunk to the third electrode layer 12 can be reduced, while the inductance therebetween can be increased, and the impedance of the phase shifter can be increased, thereby realizing the broadband of the phase shifter.

Apparently, the first opening 121 may be a non-rectangular slot, and the shape of the first opening 121 is not limited in the embodiments of the present disclosure.

In some examples, the first reference electrode 111 and the second reference electrode 112 in the second electrode layer 21 may be ground electrodes, and in this case, the first reference electrode 111 and the second reference electrode 112 may be electrically connected to the third electrode layer 12. In this manner, reduced wiring and easy control can be achieved. Specifically, the first reference electrode 111 and the second reference electrode 112 in the second electrode layer 21 may be electrically connected to a transfer electrode on the first dielectric substrate 10 through a conductive gold ball, and in this case, the transfer electrode is electrically connected to the third electrode layer 12 through a via running through the first dielectric substrate 10.

In some examples, a plurality of first branches 212 and a plurality of second branches 213 are provided in the first electrode layer 11 in one-to-one correspondence. In an embodiment of the present disclosure, the first branches 212 may be periodically arranged and electrically connected to the signal electrode 211, and similarly, the second branches 213 may also be periodically arranged and electrically connected to the signal electrode 211.

In some examples, each of the first electrode layer 11 and the second electrode layer 21 maybe a single-layer film layer made of any one of molybdenum, aluminum or copper, or may be a composite film layer made of more than one of molybdenum, aluminum and copper. The first electrode layer 11 maybe formed on the first dielectric substrate 10 by electroplating or sputtering. The second electrode layer 21 maybe formed on the second dielectric substrate 20 by electroplating or sputtering.

In some examples, the third electrode layer 12 maybe a single-layer film layer made of any one of copper, silver or gold, or may be a composite film layer made of more than one of molybdenum, aluminum and copper. The third electrode layer 12 maybe formed on the first dielectric substrate 10 by electroplating or sputtering.

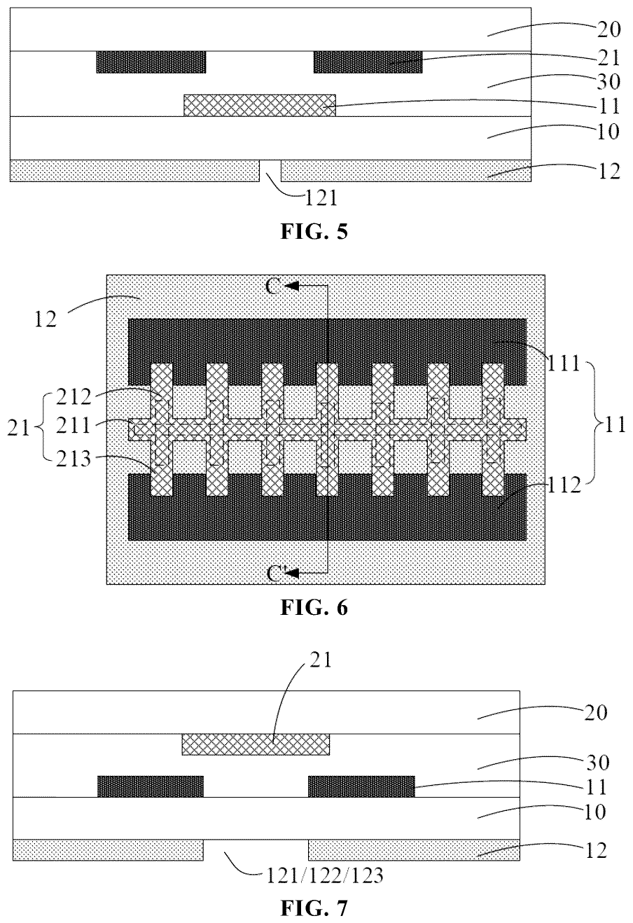

Third example: FIG. 6 is a top view of a third example of phase shifter according to an embodiment of the present disclosure; FIG. 7 is a sectional view taken along C-C′ in FIG. 6; and FIG. 8 is a top view of a third electrode layer 12 in the third example of phase shifter according to an embodiment of the present disclosure. As shown in FIGS. 6 to 8, the phase shifter has substantially the same structure as those in the first and second examples. In this example, the case where the second electrode layer 21 includes a signal electrode 211 as well as a first branch 212 and a second branch 213, and the first electrode layer 11 includes a first reference electrode 111 and a second reference electrode 112 is taken as an example for illustration. An orthographic projection of the signal electrode 211 on the first dielectric substrate 10 is located between orthographic projections of the first reference electrode 111 and the second reference electrode 112 on the first dielectric substrate 10, orthographic projections of the first branch 212 and the first reference electrode 111 on the first dielectric substrate 10 are at least partially overlapped, and orthographic projections of the second branch 213 and the second reference electrode 112 on the first dielectric substrate 10 are at least partially overlapped. The signal electrode 211 serves as a trunk of the first electrode layer 11 for transmitting electromagnetic waves. The first branch 212 and the second branch 213 serve as branches of the first electrode layer 11 to form overlap capacitances with the first reference electrode 111 and the second reference electrode 112, which overlap capacitances are used for phase shift of the electromagnetic waves transmitted by the trunk.

In this example, the first branch 212 includes a first portion and a second portion, and orthographic projections of the second portion and the first reference electrode 111 on the first dielectric substrate 10 are overlapped. The second branch 213 includes a third portion and a fourth portion, and orthographic projections of the fourth portion and the second reference electrode 112 on the first dielectric substrate 10 are overlapped. The third electrode layer 12 has a first opening 121, second openings 122, and third openings 123. Orthographic projections of the first opening 121 and the signal electrode 211 on the first dielectric substrate 10 are partially overlapped. The second openings 122 is provided in one-to-one correspondence with the first portions of the first branches 212, and orthographic projections of the corresponding second opening 122 and first portion of the first branch 212 on the first dielectric substrate 10 are partially overlapped. The third openings 123 is provided in one-to-one correspondence with the third portions of the second branches 213, and orthographic projections of the corresponding third opening 123 and third portion of the second branch 213 on the first dielectric substrate 10 are partially overlapped.

In this example, the signal electrode 211 is as the trunk, and the first branch 212 and the second branch 213 serve as branches, so that not only the capacitance from the trunk to the third electrode layer 12, but also the capacitance from the first branch 212 and the second branch 213 to the third electrode layer 12 can be reduced, while the inductance therebetween can be increased, and the impedance of the phase shifter can be increased, thereby realizing the broadband of the phase shifter.

In some examples, both the second opening 122 and the third opening 123 are in communication with the first opening 121. Orthographic projections of the first opening 121 and the signal electrode 211 on the first dielectric substrate 10 are partially overlapped. For example: the first opening 121, the second opening 122 and the third opening 123 are all rectangular slots, and in this case, a center line of the first opening 121 in an extending direction thereof coincides with a center line of the signal electrode 211 in an extending direction thereof. Similarly, orthographic projections of center lines of the corresponding second opening 122 and first branch 212 in their respective extending directions on the first dielectric substrate 10 coincide, and orthographic projections of center lines of the corresponding third opening 123 and second branch 213 in their respective extending directions on the first dielectric substrate 10 coincide.

Apparently, the first opening 121, the second opening 122 and the third opening 123 may be non-rectangular slots, and the shape of the first opening 121 is not limited in the embodiments of the present disclosure.

In some examples, the first reference electrode 111 and the second reference electrode 112 in the first electrode layer 11 may be ground electrodes, and in this case, the first reference electrode 111 and the second reference electrode 112 may be electrically connected to the third electrode layer 12. The arrangement mode can reduce wiring and is easy to control. Specifically, the first reference electrode 111 and the second reference electrode 112 in the first electrode layer 11 maybe electrically connected to the third electrode layer 12 through a via running through the first dielectric substrate 10.

In some examples, a plurality of first branches 212 and a plurality of second branches 213 are provided in the second electrode layer 21 in one-to-one correspondence. In an embodiment of the present disclosure, the first branches 212 may be periodically arranged and electrically connected to the signal electrode 211, and similarly, the second branches 213 may also be periodically arranged and electrically connected to the signal electrode 211.

In some examples, each of the first electrode layer 11 and the second electrode layer 21 maybe a single-layer film layer made of any one of molybdenum, aluminum or copper, or may be a composite film layer made of more than one of molybdenum, aluminum and copper. The first electrode layer 11 maybe formed on the second dielectric substrate 20 by electroplating or sputtering. The second electrode layer 21 maybe formed on the first dielectric substrate 10 by electroplating or sputtering.

In some examples, the third electrode layer 12 maybe a single-layer film layer made of any one of copper, silver or gold, or may be a composite film layer made of more than one of molybdenum, aluminum and copper. The third electrode layer 12 maybe formed on the first dielectric substrate 10 by electroplating or sputtering.

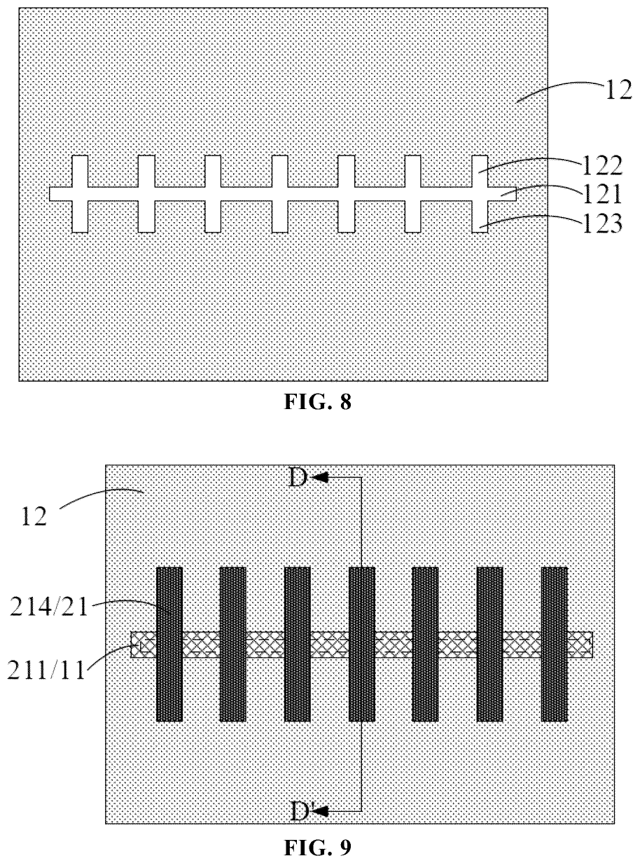

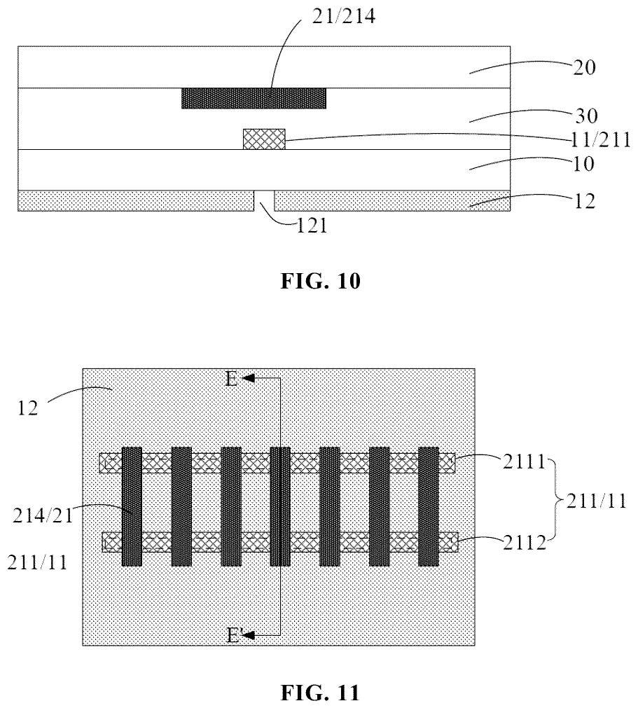

Fourth example: FIG. 9 is a top view of a fourth example of phase shifter according to an embodiment of the present disclosure; and FIG. 10 is a sectional view taken along D-D′ in FIG. 9. As shown in FIGS. 9 and 10, in this example, the phase shifter includes a first dielectric substrate 10, a second dielectric substrate 20, a liquid crystal layer 30, a first electrode layer 11, a second electrode layer 21, and a third electrode layer 12. The first dielectric substrate 10 and the second dielectric substrate 20 are disposed opposite to each other, the liquid crystal layer 30 is located between the first dielectric substrate 10 and the second dielectric substrate 20, the first electrode layer 11 is disposed on a side of the first dielectric substrate 10 close to the liquid crystal layer 30, the second electrode layer 21 is disposed on a side of the second dielectric substrate 20 close to the liquid crystal layer 30, and the third electrode layer 12 is disposed on a side of the first dielectric substrate 10 away from the liquid crystal layer 30. The liquid crystal layer 30 is provided at least in an overlap region of the first electrode layer 11 and the second electrode layer 21. The first electrode layer 11 of the phase shifter includes a signal electrode 211, and the second electrode layer 21 includes a plurality of patch electrodes 214 arranged side by side in an extending direction of the signal electrode 211. Each of the patch electrodes 214 has an orthographic projection on the first dielectric substrate 10 overlapped with the orthographic projection of the signal electrode 211 on the first dielectric substrate 10, thereby forming overlap capacitances which are used for phase shift of the electromagnetic waves transmitted by the signal electrode 211. The third electrode layer 12 has a first opening 121, and orthographic projections of the first opening 121 and the signal electrode 211 on the first dielectric substrate 10 are partially overlapped. For example: the first opening 121 is a rectangular slot, and in this case, a center line of the first opening 121 in an extending direction thereof coincides with a center line of the signal electrode 211 in an extending direction thereof. In this case, for the signal electrode 211 as the trunk, the capacitance from the trunk to the third electrode layer 12 can be reduced, while the inductance therebetween can be increased, and the impedance of the phase shifter can be increased, thereby realizing the broadband of the phase shifter.

Apparently, the first opening 121 may be a non-rectangular slot, and the shape of the first opening 121 is not limited in the embodiments of the present disclosure.

In some examples, the respective patch electrodes 214 may be electrically connected to one bias voltage line, which may reduce wiring and facilitate control. Apparently, the patch electrodes 214 may be electrically connected to separate bias voltage lines so that the patch electrodes 214 can be controlled individually.

In some examples, each of the first electrode layer 11 and the second electrode layer 21 maybe a single-layer film layer made of any one of molybdenum, aluminum or copper, or may be a composite film layer made of more than one of molybdenum, aluminum and copper. The first electrode layer 11 maybe formed on the second dielectric substrate 20 by electroplating or sputtering. The second electrode layer 21 maybe formed on the first dielectric substrate 10 by electroplating or sputtering.

In some examples, the third electrode layer 12 maybe a single-layer film layer made of any one of copper, silver or gold, or may be a composite film layer made of more than one of molybdenum, aluminum and copper. The third electrode layer 12 maybe formed on the first dielectric substrate 10 by electroplating or sputtering.

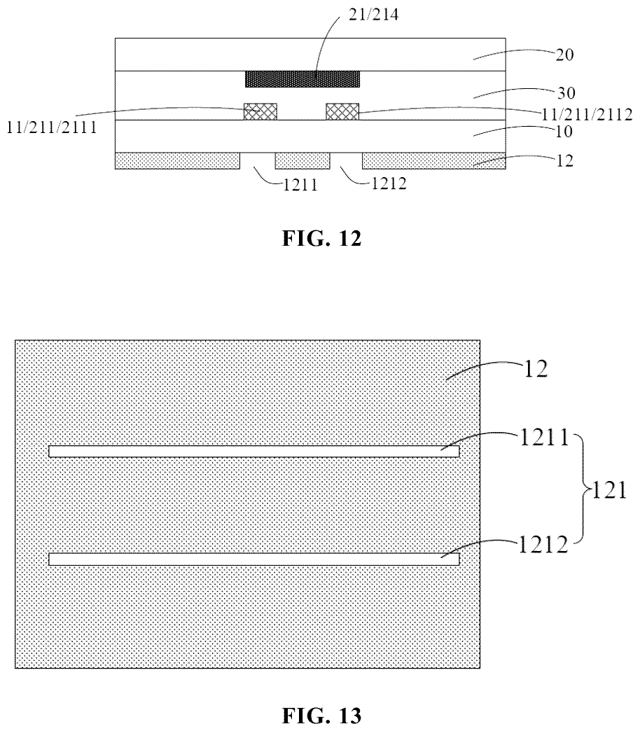

Fifth example: FIG. 11 is a top view of a fifth example of phase shifter according to an embodiment of the present disclosure; FIG. 12 is a sectional view taken along E-E′ in FIG. 11; and FIG. 13 is a top view of a third electrode layer 12 in the fifth example of phase shifter according to an embodiment of the present disclosure. As shown in FIGS. 11 to 13, in this example, the phase shifter includes a first dielectric substrate 10, a second dielectric substrate 20, a liquid crystal layer 30, a first electrode layer 11, a second electrode layer 21, and a third electrode layer 12. The first dielectric substrate 10 and the second dielectric substrate 20 are disposed opposite to each other, the liquid crystal layer 30 is located between the first dielectric substrate 10 and the second dielectric substrate 20, the first electrode layer 11 is disposed on a side of the first dielectric substrate 10 close to the liquid crystal layer 30, the second electrode layer 21 is disposed on a side of the second dielectric substrate 20 close to the liquid crystal layer 30, and the third electrode layer 12 is disposed on a side of the first dielectric substrate 10 away from the liquid crystal layer 30. The liquid crystal layer 30 is provided at least in an overlap region of the first electrode layer 11 and the second electrode layer 21. The first electrode layer 11 includes a signal electrode 211, and the signal electrode 211 includes a first signal sub-electrode 2111 and a second signal sub-electrode 2112 arranged side by side. The second electrode layer 21 includes a plurality of patch electrodes 214 arranged side by side in an extending direction of the first signal sub-electrode 2111. Two ends of each patch electrode 214 on the first dielectric substrate 10 are respectively overlapped with orthographic projections of the first signal sub-electrode 2111 and the second signal sub-electrode 2112 on the first dielectric substrate 10, thereby forming overlap capacitances which are used for phase shift of the transmitted electromagnetic waves.

In this example, the third electrode layer 12 has a first opening 121, and the first opening 121 includes a first sub-opening 1211 and a second sub-opening 1212. The first sub-opening 1211 and the second sub-opening 1212 are rectangular slots. Orthographic projections of the first signal sub-electrode 2111 and the first sub-opening 1211 on the first dielectric substrate 10 are partially overlapped; and orthographic projections of the second signal sub-electrode 2112 and the second sub-opening 1212 on the first dielectric substrate 10 are partially overlapped. In this manner, the capacitance formed by the first signal sub-electrode 2111 and the third electrode layer 12, and the capacitance formed by the second signal sub-electrode 2112 and the third electrode layer 12, each can be reduced, while the inductance therebetween can be increased, and the impedance of the phase shifter can be increased, thereby realizing the broadband of the phase shifter.

In some examples, orthographic projections of center lines of the first sub-opening 1211 and first electrode 2111 in their respective extending directions on the first dielectric substrate 10 coincide, and orthographic projections of center lines of the second sub-opening 1212 and the second signal sub-electrode 2112 in their respective extending directions on the first dielectric substrate 10 coincide.

In some examples, each of the first electrode layer 11 and the second electrode layer 21 maybe a single-layer film layer made of any one of molybdenum, aluminum or copper, or may be a composite film layer made of more than one of molybdenum, aluminum and copper. The first electrode layer 11 maybe formed on the second dielectric substrate 20 by electroplating or sputtering. The second electrode layer 21 maybe formed on the first dielectric substrate 10 by electroplating or sputtering.

In some examples, the third electrode layer 12 maybe a single-layer film layer made of any one of copper, silver or gold, or may be a composite film layer made of more than one of molybdenum, aluminum and copper. The third electrode layer 12 maybe formed on the first dielectric substrate 10 by electroplating or sputtering.

In any of the above examples, the liquid crystal layer 30 has a thickness not less than 1/10 μm. The first dielectric substrate 10 and the second dielectric substrate 20 are each made of a material including, not limited to, glass, PCB, or a flexible membrane material.

According to the phase shifter in the embodiments of the present disclosure, by means of the opening in the third electrode layer 12, the capacitance formed by the signal electrode 211 and third electrode layer 12 is reduced, so that the phase shifter can achieve an impedance bandwidth of more than 20% to 30%. Meanwhile, this facilitates optimization of the broadband phase shifter FOM, reduction of the metal machining tolerance risk, as well as the miniaturized design of devices.

In a second aspect, an embodiment of the present disclosure provides an antenna, including a phase shifter as described above, and a radiation unit connected to the phase shifter. Apparently, the antenna further includes a feed structure electrically connected to the radiation unit through the phase shifter. Electromagnetic waves are fed into the phase shifter by the feed structure, subjected to phase adjustment in the phase shifter, and then radiated through the radiation unit, thereby changing the pattern.

The antenna further includes a transceiver unit, a radio frequency transceiver, a signal amplifier, a power amplifier, and a filter unit. The antenna may be used as a transmitting antenna or a receiving antenna. The transceiver unit may include a baseband and a receiving end. The baseband provides signals of at least one frequency band, for example, 2G signals, 3G signals, 4G signals, 5G signals, or the like, and transmits the signals of the at least one frequency band to the radio frequency transceiver. After being received by the transparent antenna in the communication system, the signals may be processed by the filter unit, the power amplifier, the signal amplifier, and the radio frequency transceiver (not shown), and then transmitted to the receiving end in the transceiver unit. The receiving end may be, for example, an intelligent gateway, or the like.

Further, the radio frequency transceiver is connected to the transceiver unit, and configured to modulate a signal sent from the transceiver unit, or demodulate a signal received by the transparent antenna and transmit the demodulated signal to the transceiver unit. Specifically, the radio frequency transceiver may include a transmitting circuit, a receiving circuit, a modulation circuit, and a demodulation circuit. After being received by the transmitting circuit, multiple types of signals provided by the baseband can be modulated by the modulation circuit and then transmitted to the antenna. Then, the transparent antenna receives and transmits the signals to the receiving circuit of the radio frequency transceiver which further transmits the signals to the demodulation circuit, where the signals are demodulated by the demodulation circuit and then transmitted to the receiving end.

Further, the radio frequency transceiver is connected to the signal amplifier and the power amplifier which are further connected to the filter unit, and the filter unit is connected to at least one antenna. In the process of transmitting signals by a communication system, the signal amplifier is configured to increase signal-to-noise ratio of signals output from the radio frequency transceiver, and then transmit the signals to the filter unit. The power amplifier is configured to amplify power of the signals output from the radio frequency transceiver, and then to transmit the signals to the filter unit. The filter unit may specifically include a duplexer and a filter circuit. The filter unit combines the signals output from the signal amplifier and the power amplifier, filters noise waves, and then transmits the signals to the transparent antenna to be radiated. In the process of receiving signals by a communication system, after being received by the antenna, the signals are transmitted to the filter unit, where the signals received by the antenna are filtered to remove noise waves by the filter unit and then transmitted to the signal amplifier and the power amplifier. The signal amplifier increases a gain of the signals received by the antenna to increase a signal-to-noise ratio of the signals; while the power amplifier amplifies a power of the signals received by the antenna. After being processed by the power amplifier and the signal amplifier, the signals received by the antenna are transmitted to the radio frequency transceiver, and then to the transceiver unit.

In some examples, the signal amplifier may include various types of signal amplifiers, such as a low noise amplifier, which is not limited herein.

In some examples, the antenna provided in the embodiments of the present disclosure further includes a power management unit connected to the power amplifier and configured to provide a voltage for signal amplification for the power amplifier.

It will be appreciated that the above implementations are merely exemplary implementations for the purpose of illustrating the principle of the present disclosure, and the present disclosure is not limited thereto. It will be apparent to those skilled in the art that various modifications and variations may be made without departing from the spirit or essence of the present disclosure. Such modifications and variations should also be considered as falling into the protection scope of the present disclosure.

1. A phase shifter, comprising a first dielectric substrate and a second dielectric substrate opposite to each other, a tunable dielectric layer between the first dielectric substrate and the second dielectric substrate, a first electrode layer on a side of the first dielectric substrate close to the tunable dielectric layer, a second electrode layer on a side of the second dielectric substrate close to the tunable dielectric layer, and a third electrode layer on a side of the first dielectric substrate away from the tunable dielectric layer; wherein
one of the first electrode layer or the second electrode layer comprises a signal electrode for transmitting electromagnetic waves; and
the third electrode layer is provided with a first opening, and orthographic projections of the first opening and the signal electrode on the first dielectric substrate are partially overlapped.

2. The phase shifter according to claim 1, wherein the first electrode layer comprises the signal electrode, the second electrode layer comprises a first reference electrode and a second reference electrode; the first electrode layer further comprises at least one first branch and at least one second branch respectively connected to two sides of an extending direction of the signal electrode; the orthographic projection of the signal electrode on the first dielectric substrate is between orthographic projections of the first reference electrode and the second reference electrode on the first dielectric substrate; orthographic projections of the at least one first branch and the first reference electrode on the first dielectric substrate are at least partially overlapped; and orthographic projections of the at least one second branch and the second reference electrode on the first dielectric substrate are at least partially overlapped, or
wherein the second electrode layer comprises the signal electrode, the first electrode layer comprises a first reference electrode and a second reference electrode, the second electrode layer further comprises at least one first branch and at least one second branch respectively connected to two sides of an extending direction of the signal electrode; the orthographic projection of the signal electrode on the first dielectric substrate is between orthographic projections of the first reference electrode and the second reference electrode on the first dielectric substrate; orthographic projections of the at least one first branch and the first reference electrode on the first dielectric substrate are at least partially overlapped; and orthographic projections of the at least one second branch and the second reference electrode on the first dielectric substrate are at least partially overlapped.

3. (canceled)

4. The phase shifter according to claim 2, wherein the at least one first branch each comprises a first portion and a second portion, and orthographic projections of the second portion and the first reference electrode on the first dielectric substrate are overlapped; the third electrode layer is further provided with a second opening, and orthographic projections of the first portion and the second opening on the first dielectric substrate are partially overlapped.

5. The phase shifter according to claim 4, wherein the second opening is in communication with the first opening; and a center line of the first portion in an extending direction of the first portion coincides with a center line of the second opening in an extending direction of the second opening.

6. (canceled)

7. The phase shifter according to claim 2, wherein a center line of the signal electrode in an extending direction of the signal electrode coincides with a center line of the first opening in an extending direction of the first opening.

8. The phase shifter according to claim 2, wherein a plurality of first branches and a plurality of second branches are provided in one-to-one correspondence.

9. The phase shifter according to claim 2, wherein the first reference electrode and the second reference electrode are each configured to be loaded with the same voltage as the third electrode layer.

10. The phase shifter according to claim 1, wherein the first electrode layer comprises the signal electrode, the second electrode layer comprises a plurality of patch electrodes arranged side by side in an extending direction of the signal electrode, and each of the patch electrodes has an orthographic projection on the first dielectric substrate overlapped with the orthographic projection of the signal electrode on the first dielectric substrate.

11. The phase shifter according to claim 10, wherein a center line of the signal electrode in an extending direction of the signal electrode coincides with a center line of the first opening in an extending direction of the first opening.

12. The phase shifter according to claim 1, wherein the first electrode layer comprises the signal electrode, the second electrode layer comprises a plurality of patch electrodes arranged side by side in an extending direction of the signal electrode; the signal electrode comprises a first signal sub-electrode and a second signal sub-electrode arranged side by side, and two ends of each patch electrode are respectively overlapped with orthographic projections of the first signal sub-electrode and the second signal sub-electrode on the first dielectric substrate; and
the first opening comprises a first sub-opening and a second sub-opening, and orthographic projections of the first signal sub-electrode and the first sub-opening on the first dielectric substrate are partially overlapped; and orthographic projections of the second signal sub-electrode and the second sub-opening on the first dielectric substrate are partially overlapped.

13. The phase shifter according to claim 12, wherein a center line of the first signal sub-electrode in an extending direction of the first signal sub-electrode coincides with a center line of the first sub-opening in an extending direction of the first sub-opening, and/or a center line of the second signal sub-electrode in an extending direction of the second signal sub-electrode coincides with a center line of the second sub-opening in an extending direction of the second sub-opening.

14. The phase shifter according to claim 1, wherein the tunable dielectric layer has a thickness not less than 1/10 μm.

15. The phase shifter according to claim 1, wherein the first electrode layer and the second electrode layer are each made of a material comprising at least one of molybdenum, aluminum or copper.

16. The phase shifter according to claim 1, wherein the third electrode layer is made of a material comprising at least one of copper, silver or gold.

17. The phase shifter according to claim 1, wherein the tunable dielectric layer is made of a material comprising liquid crystal molecules.

18. An antenna, comprising the phase shifter according to claim 1.

19. The antenna according to claim 18, further comprising a radiation unit electrically connected to the phase shifter.

20. The antenna according to claim 19, further comprising a feed unit electrically connected to the radiation unit through the phase shifter.

21. The phase shifter according to claim 2, wherein the at least one second branch each comprises a third portion and a fourth portion, and orthographic projections of the fourth portion and the second reference electrode on the first dielectric substrate are overlapped; and the third electrode layer is further provided with a third opening, and orthographic projections of the third portion and the third opening on the first dielectric substrate are partially overlapped.

22. The phase shifter according to claim 21, wherein the third opening is in communication with the first opening; and a center line of the third portion in an extending direction of the third portion coincides with a center line of the third opening in an extending direction of the third opening.
